(19) United States
(12) Patent Application Publication
(10) Pub. No.: US 2007/0291743 A1
(43) Pub. Date: Dec. 20, 2007

(54) DETECTION OF LOOPS WITHIN A SIP SIGNALLING PROXY

(75) Inventors: Thomas Froment, Longpont Sur Orge (FR); Christophe Lebel, Haute Goulaine (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/762,759

(22) Filed: Jun. 13, 2007

(30) Foreign Application Priority Data
Jun. 16, 2006 (FR) 0652162

(51) Int. Cl. H04L 12/66

(52) U.S. Cl. 370/352

(57) ABSTRACT

SIP Proxy comprising a loop detection mechanism (LD) consisting of calculating a signature for an incoming signalling message from a set of parameters for said incoming signalling message, and detecting a loop by comparing this signature with values inserted in a particular parameter of the incoming signalling message, characterised in that said sending means (EMS) insert the signature in the particular parameter of the outgoing signalling message (ms) corresponding to the incoming signalling message (me). It is applicable to IMS (“Internet Multimedia Subsystem”) type communication architectures.

This invention relates to signalling to set up multimedia sessions on packet communication networks, and more particularly relates to use of the SIP (Session Initiation Protocol) protocol on such networks.

One particular application of the invention is in IMS (Internet Multimedia Subsystem) type network architectures, as defined by 3GPP and TiSpan standardization organizations that recommend the SIP protocol as the exclusive signalling protocol.

This SIP protocol is described in the RFC 3261 produced by the IETF (Internet Engineering Task Force). Its purpose is to enable setting up and control (modification, termination, etc.) of a multimedia session on a packet communication network operating on an IP (Internet Protocol) protocol stack. It enables both parties in a multimedia session to authenticate each other, to determine each other's location and possibly to negotiate the type of media that could be used for transport of the session itself.

There are other protocols with similar objectives, such as MGCP or H.323, established by the ITU (International Telecommunication Union), but the SIP protocol is now currently becoming preponderant, particularly due to its selection as a signalling protocol for IMS architectures by the 3GPP.

The SIP protocol recognizes essentially two types of elements used in a communication network: “user agents”, and “SIP proxies”. User agents are mainly terminals such as microcomputers, SIP telephones, or Personal Digital Assistants (PDA).

These terminals have an IP (Internet Protocol) address that “physically” locates and routes messages; and also a Uniform Resource Identifier (URI) that is a more abstract identifier and is used to identify a terminal independently of its physical IP address.

If a calling terminal knows the IP address of the terminal that it wants to call, it can initiate the session by sending it an SIP query to its IP address. However, general speaking, terminals only know each other mutually through their uniform resource identifier URI.

A second type of network element is the SIP proxy. Conventionally, SIP messages transit through these SIP proxies that have the main task of making associations between IP addresses and uniform resource identifiers URI: thus, the sending terminal transmits a message to the URI of the called terminal, and the SIP proxy(ies) that can access associations between IP and URI addresses are capable of routing the message to the called terminal.

Another role of SIP proxies is to call upon application servers. These applications may be of very different types. Examples include invoicing applications, call control applications (filtering, call forward, voice boxes, etc.), games, convergence applications capable of causing interaction between several protocols, etc.

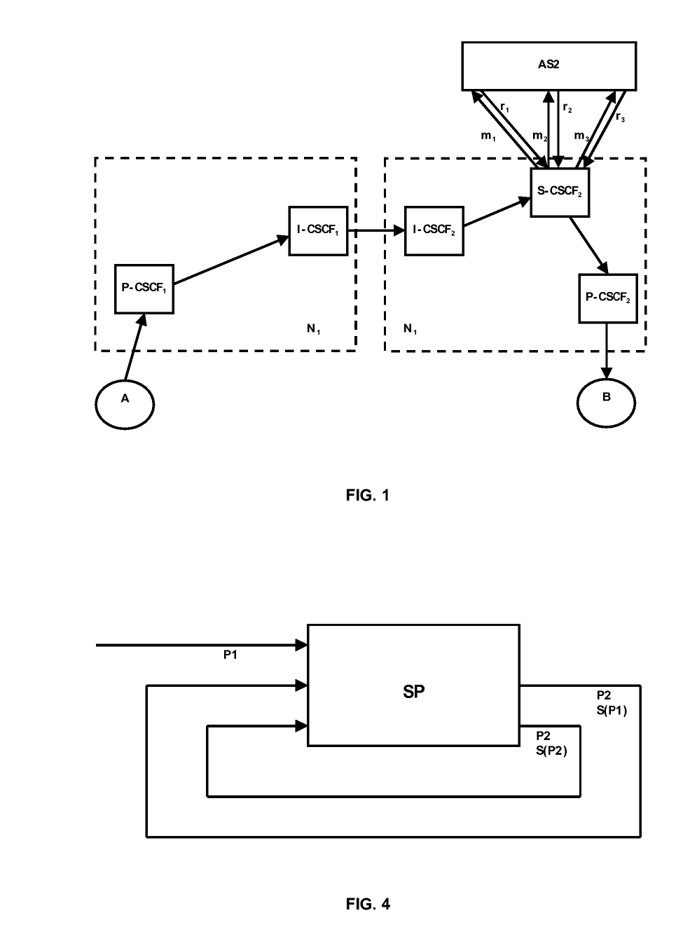

FIG. 1 illustrates a typical IMS (Internet Multimedia Subsystem) type architecture comprising two networks N₁ and N₂. A terminal A is connected to the first network and a terminal B is connected to the second network.

The terminals A and B are connected to their corresponding networks through SIP proxies P-CSCF₁ and P-CSCF₂ respectively. The main task of the SIP proxies P-CSCF “Proxy—Call Session Control Function” is to provide input points to terminals.

The two networks N₁ and N₂ also comprise SIP proxies I-CSCF₁ and I-CSCF₂ “Interrogating—Call Session Control Function” respectively, the purpose of which is to supply interfaces to other communication networks, and SIP proxies S-CSCF₁ and S-CSCF₂ “Serving—Call Session Control Function”, respectively to interface the telecommunication network with one or several application servers AP₂, comprising different types of services, as mentioned above.

An SIP query is sent by terminal A so as to set up a session with the terminal B. This SIP query is a “guest” query comprising the uniform resource identifier URI of terminal B. This query is transmitted to the functional proxy P-CSCF₁ that is the only known input point of terminal A. Terminal A determines that terminal B is not in the communication network N₁ and therefore transmits the query to the l-CSCF₁ functional proxy that itself sends it to its alter-ego l-CSCF₂ in the communication network N₂. Communication network N₂ transmits the SIP query to the functional proxy S-CSCF₂ so that the services provided for terminal B (if any) can be implemented (payment, filtering, call forwarding, etc.).

For each service provided, a modified SIP query is transmitted to the application server AP₂. In the example in FIG. 1, three queries m₁, m₂, m₃ are transmitted generating three responses from the application server r₁, r₂, r₃.

Communication networks are tending to become more complex, particularly due to the increasing number of terminals that can connect and available services, and therefore more SIP signalling is becoming necessary and more difficult to control.

In some cases, it is possible that an SIP message will pass through the same SIP proxy several times without being modified. It is important to recognise this phenomenon that is usually called a “loop” in the spiral. In a spiral, the SIP message also passes through the same proxy several times, but it is modified during each pass. Thus, the situation illustrated in FIG. 1 in which SIP messages m₁, m₂, m₃, r₁, r₂, r₃ are exchanged between the SIP proxy S-CSCF₂ and the application server AP₂ is a conventional spiral case.

The spiral is a normal behaviour of SIP signalling, but loops are abnormal phenomena.

Section 6 “Definitions” in RFC 3261 contains definitions of these loops and spiral phenomena.

RFC 3261 mentioned above allowed for using loop detection means by SIP proxies in sections 16.3 and 16.6.

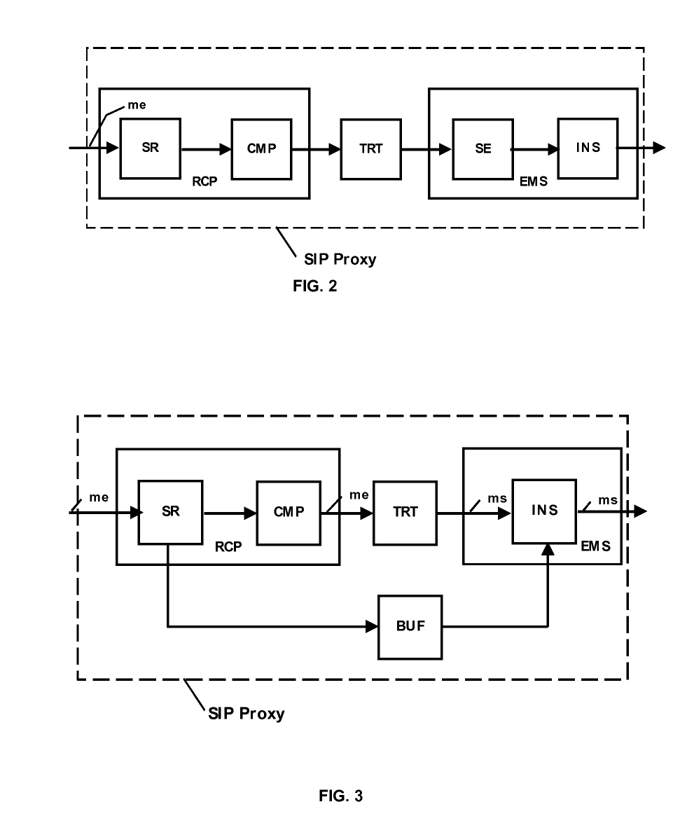

The principle described is shown diagrammatically in FIG. 2.

The SIP proxy comprises reception means RCP for incoming signalling messages “me”, processing means TRT to produce outgoing signalling messages “ms” from said incoming signalling messages “me”, possibly modifying some of their parameters, and sending means EMS to retransmit outgoing signalling messages (ms) to the communication network.

A loop is detected by including two modules SR and SE in the reception means, to calculate signatures on a set of parameters for incoming messages (me) and outgoing messages (ms), respectively.

At the output from module SR, the reception means comprise a module CMP to compare the result of the signature calculation with a value inserted in a particular parameter of the incoming message.

If the calculated signature is equal to this value, then the identical message has already been received and a loop (and not a spiral) is taking place. The incoming message can then be destroyed and a loop detection error message sent to the sender.

Otherwise, the incoming message is processed in a manner known in itself by processing means and is transformed into an outgoing message that, during normal behaviour, must be different from the incoming message, by the value of one or several parameters. Thus, the parameters defining the path taken by the message would normally have to be modified.

The SE module calculates a new signature based on these modified parameters and an insertion module INS inserts this signature in the particular parameter.

Thus, loops are detected by the lack of change of signalling message parameters (particularly parameters concerning the path to be taken).

However, the IETF RFC considers this mechanism to be optional. Since it is extremely expensive in terms of machine resources, it has apparently never been implemented.

The loop detection mechanism recommended by RFC 3261 has the major disadvantage that it requires two signature calculations in modules SR and SE. These signature calculations are complex operations. Since the SIP protocol is a text protocol, they require manipulation of long character strings, which is expensive in terms of machine resources for SIP proxies.

Another much simpler mechanism is necessarily used that consists of decrementing a “Max Forward” counter every time that an SIP proxy is used, and considering that once this counter is decremented to zero, the message must make a loop and interrupt its retransmission. This mechanism is also described in RFC 3261.

But very recently it has been observed that it is extremely important to limit loops in SIP signalling and that the iteration counter mechanism is very inadequate.

The draft-ieff-sip-fork-loop-fix-01.txt document published in March 2006 and available on the IETF internet site presents a situation in which a malicious person could block a communication network with very little effort. By recording two terminals with two SIP proxies in a particular configuration, each message addressed to these terminals will be duplicated by the SIP proxies and forwarded to the other SIP proxy. This forwarding and duplication procedure causes a combinational explosion that is limited only by the “Max Forward” counter. Traditionally, this counter is fixed to a value equal to 80, which gives a good compromise between the number of SIP proxies that an SIP message can accept during normal behaviour, and what occurs during abnormal behaviour of the loop.

With a value of this magnitude, the final result is a total of 2⁷⁰ SIP messages, which can block a communication network for several hours.

Apart from this extreme but possible case of malicious attacks, this document describes the vulnerability of architectures based on the SIP protocol.

Therefore, it is of overriding importance to set up loop detection mechanisms in SIP proxies.

The purpose of this invention is to present a loop detection mechanism that has the advantage of requiring fewer machine resources.

More precisely, the first purpose of the invention is an SIP Proxy comprising:
means of reception of incoming signalling messages conforming with the SIP protocol and originating from a communication network,
processing means to provide outgoing signalling messages from these incoming signalling messages, possibly modifying some of their parameters, and
sending means to send outgoing signalling messages onto the communication network that comprises a loop detection mechanism, consisting of calculating a signature for an incoming signalling message from a set of parameters for this message, and detecting a loop by comparing this signature with values inserted in a particular parameter of the incoming signalling message.

The SIP proxy according to the invention is innovative in that the sending means insert the signature in the particular parameter of the outgoing signalling message corresponding to the incoming signalling message.

Thus, a single signature calculation is carried out by the SIP proxies, within the reception means.

This represents most of the extra cost involved in detection of loops, therefore the mechanism according to the invention reduces this extra cost by half.

It then becomes possible to implement a loop detection mechanism by minimizing the extra cost on the normal SIP signalling traffic.

A second purpose of the invention is a communication architecture conforming with the IMS standard, comprising a plurality of P-CSCF, I-CSCF and S-CSCF type SIP proxies in which at least one SIP proxy is conforming with the first purpose of the invention described above.

A third purpose of the invention is a process for transmission of signalling messages, particularly conforming with the SIP protocol, within a set of SIP proxies in a communication network, in which each SIP proxy passed through:
receives an incoming signalling message,
outputs an outgoing signalling message from this incoming signalling message, possibly modifying some of its parameters, and
sends the outgoing signalling message.

A loop detection mechanism is used that consists of calculating a signature starting from a set of parameters of the incoming signalling message, and detecting a loop by comparing this signature with values inserted in a particular parameter of the incoming signalling message.

The method according to the invention is characterized in that the signature is inserted in the particular parameter of the outgoing signalling message corresponding to the incoming signalling message.

The invention and its advantages will appear more clearly from the following description with relation to the related figures.

FIG. 1, already commented upon, shows an IMS type network architecture.

FIG. 2, also already commented upon, diagrammatically shows the data stream used for loop detection within an SIP proxy according to the state-of-the-art described in IETF RFC 3261.

FIG. 3 diagrammatically shows the data stream and the functional architecture possible for an SIP proxy according to the invention.

FIG. 4 shows an example loop detection by an SIP proxy according to the invention.

In a manner known in itself, an SIP-Proxy can be functionally divided into reception means RCP, processing means TRT and sending means EMS.

The reception means are RCP receive signalling messages “me” originating from a communication network through input interfaces of the SIP proxy.

These signalling messages “me” are conforming with the SIP protocol as currently defined by the IETF RFC 3261 and by extensions that enrich this basic protocol. Examples of extensions to the SIP protocol include RFC 3265, “Session Initiation Protocol (SIP)—Specific Event Notification”, and RFC 3262, “Reliability of Provisional Responses in the Session Initiation Protocol (SIP)”.

The reception means RCP comprise a module SR to calculate a signature from a set of incoming signalling message parameters.

This set of parameters is supplied by RFC 3261. It consists of:
the tag of the “From” and “To” parameters that identify the logical name of the sender and the destination of the signalling message.
the “Call ID” parameter that identifies a session between two parties.
the “Route” parameter that gives the path to be followed to route the message to its final destination.
the “Query URI” parameter that gives the Uniform Resource Identifier URI of the destination. If there is no “Route” parameter, then this parameter is modified at each hop by the value corresponding to the next SIP Proxy to be reached, to achieve the routing and the message gradually moves closer to its final destination.
the CSeq parameter that indicates an order number of the signalling message within a session.
The “Proxy require” and “proxy authorization” parameters that are used for negotiation of services and authentication between two SIP proxies or between an SIP proxy and an application server, respectively.
and the final “Via” parameter in the list that contains information about the previous SIP proxy.

These parameters are not further described herein, but a person skilled in the art would be capable of referring to RFC 3261 or any other documentation about the SIP protocol, to better understand the contents and use of these different parameters.

However, the “Via” parameter deserves a more detailed study. Each SIP proxy adds a new “Via” parameter comprising at least the address at which it wants to receive a response, and a single (“branch”) identifier that it uses to correlate the response with the sent message. This unique identifier is generated partly at random.

Therefore, a signalling message includes a “Via” parameter list. The last in the list corresponds to the last SIP proxy through which the signalling message passes.

An example of an SIP signalling message (or beginning of an SIP signalling message) is given below:

INVITE sip:bob@biloxi.example.com SIP/2.0

Via: SIP/2.0/TCP ss1.atlanta.example.com:5060;branch=z9hG4bK2d4790.1

Via: SIP/2.0/TCP client.atlanta.example.com:5060;branch=z9hG4bK74bf9; received=192.0.2.101

Max-Forwards: 69

Record-Route: <sip:ss1.atlanta.example.com;lr>

From: Alice <sip:alice@atlanta.example.com>;tag=9fxced76sl

To: Bob <sip:bob@biloxi.example.com>

Call-ID: 3848276298220188511@atlanta.example.com

CSeq: 2 INVITE

Contact: <sip:alice@client.atlanta.example.com;transport=tcp>

According to RFC 3261, the last “Via” parameter in the list must be taken in its entirety. But this more detailed study shows that the unique identifier must be extracted from the set of parameters to be considered; since it is partly generated at random, it will be different every time. A message that would be only modified by the value of this “branch” parameter would be in a loop situation. Thus, the algorithm proposed by RFC 3261 is incapable of detecting a loop and must be modified.

According to one embodiment of the invention, all parameters to be considered comprise the last “Via” parameter in the list, excluding this single random identifier.

Furthermore, this set of parameters should preferably consist of the set of parameters mentioned above, but it is still possible to add any other parameter defined by extensions to the SIP protocol to this list, if it influences routing of SIP messages within a network.

More recent work since the priority date of this application has described the list to be taken into account to calculate the signature. This work is currently presented in the IETF draft “draft-ieff-sip-fork-loop-fix-04.txt” that is currently becoming an RFC (Request for Comment).

This document makes it compulsory to set up a loop detection mechanism using a signature calculation and therefore to make the problem described above even more crucial.

Therefore according to one embodiment of the invention, all parameters are conforming with “draft-ieff-sip-fork-loop-fix-04.txt” (and with the subsequent RFC).

A signature is then calculated starting from this set of parameters. A signature is reduced data representative of this set of parameters. For a set of identical parameters, the signature will always be the same, so that studying values of the signature are sufficient to draw conclusions about the variation of all parameters.

This calculation is typically conforming with the IETF RFC 1321, entitled “MD5—Message Digest Algorithm 5”. The signature is then a hexadecimal string representative of all parameters considered.

The purpose of this CMP module is then to compare this signature with a list of values inserted in a particular parameter of the incoming signalling message “me”.

This particular parameter may be the “branch” parameter of the “Via” parameter, and the value may be inserted in this parameter at a clearly defined location, for example following the identifier mentioned above and separated from it by a dash.

If these two values are equal, then the incoming signalling message “me” has not been modified since it was last processed by an SIP proxy. Since the set of parameters taken into consideration includes the addresses of the functional destination element of the message, this means that the final processing has been done by the same SIP proxy as the current proxy that is now processing it again. Therefore we are now in a loop.

The incoming signalling message “me” can then be destroyed, and an error message can be sent to the sender. For example, it may be a type 482 (“Loop Detected”) error message.

If the signature and the value inserted in a particular parameter of the incoming signalling message “me” are different, then we are not in a loop and the incoming signalling message is sent to the processing means TRT. At the same time, the signature is memorized in a BUF memory.

The processing done by the processing module TRT complies with the state-of-the-art and the information given in RFC 3261.

Incoming signalling messages are normally modified to give outgoing signalling messages ms. Modifications deal with parameters related to routing of signalling messages: as we have seen above, the mechanism inherent to the SIP protocol consists of modifying some parameters at each hop so as to route the signalling message towards its final destination.

Thus, a failure to change the set of parameters may be seen as an abnormal loop behaviour.

Outgoing signalling messages (ms) are then transmitted to sending means EMS. These sending means comprise essentially an insertion module INS with the purpose of inserting the signature memorized in the BUF memory into the particular parameter of the outgoing signalling message corresponding to the incoming signalling message which was used to calculate the signature.

The particular parameter and the precise location within this particular parameter is identical to that used for comparison by the comparison module CMP.

Compared with the state-of-the-art presented in RFC 3261, a single signature calculation is carried out by the SIP proxy. This is made possible because the calculation made as input is used for insertion as output.

A person skilled in the art will realize that the signature inserted in outgoing signalling messages ms is inconsistent with the values of the set of parameters considered. Therefore, a priori this invention will not provide the expected result.

However, the example provided in FIG. 4 can give more details of the operation of an SIP proxy according to the invention. A signalling message enters into the SIP proxy SP with a set of parameters P1. The SIP proxy SP calculates the signature S[P1] on this set of parameters P1, and then modifies the parameters into a second set of parameters P2 and finally transmits an outgoing signalling message containing the set of parameters P2 and the signature S[P1].

This signalling message is then transmitted to the same SIP proxy SP, either directly or through other SIP proxies (not shown).

A new signature s[P2] is then calculated, and the SIP proxy compares this signature s[P2] with the signature s[P1] contained in a particular parameter of the incoming message. Since these signatures are different, the loop is not detected, whereas the SIP proxy conforming with the mechanism described in RFC 3261 would have detected it.

Therefore, the message is transmitted to the processing means. But since we are in a loop situation, not all parameters P2 are modified and therefore the outgoing signalling message contains the same set of parameters P2, with the signature s[P2] calculated at the input.

When this message is input again, the SIP proxy then detects that the signature calculated on all parameters P2 of the signalling message and the signature that it contains are identical. It detects the loop and it can interrupt processing of the message.

It can then send a loop detection error message that returns along the path followed by the signalling message.

Thus, finally, the SIP proxy according to the invention can detect loops. An additional loop is made, but the cost of this additional loop and the unnecessary signalling traffic that it represents is considered to be not very useful in comparison with the gain in calculation resources due to the single signature calculation.

According to one particular embodiment of the invention, additional optimisation is possible by inserting a marker in outgoing messages and not making any signature calculation if there is no identifier marker in the incoming signalling message. In other words, the loop detection mechanism is active only if the incoming signalling message contains a marker that identifies the signalling element.

For example, this mechanism was described in discussions about the IETF “draft-campen-sipping-stack-loop-detect-00.txt” draft.

It is based on the concept that if a message does not contain its marker, then it has never passed through the SIP proxy and therefore is not in a loop.

According to the invention, this marker must be a marker representative of the SIP proxy and must univocally represent it within the communication network.

Therefore in the case of an SIP proxy belonging to a public network, it must be a univocal marker throughout this entire public network. Therefore, it must be unique throughout the world.

Thus, an element receiving a message containing a marker is capable of unambiguously determining whether or not the message has already passed through it.

For example, the marker may be based on the physical address of the SIP proxy. For example, it may be its MAC “Media Access Control” address. There are several types of MAC addresses and they may be used, particularly MAC-48, EUI-48 and EUI-64 defined by the IEEE (Institution of Electrical and Electronics Engineers).

The marker may also be based on the IP address of the SIP proxy.

The marker may be exactly equal to this physical address (MAC or IP or others) or it may contain it with other parameters, or it may be deduced from the physical address by a translation that keeps its univocal nature.

The marker may also be obtained from a dedicated naming server, the role of which will be to assign univocal identifiers to all SIP proxies.

This marker may be inserted in different locations in signalling messages.

According to a first embodiment, the marker is inserted in a standard and unique location of signalling messages (incoming and outgoing). It may be a specific header of the SIP protocol, normalized with the IETF. However, such an implementation would require that all existing communication terminals would have to be modified to make them conforming with this new standardization and capable of interpreting received signalling messages and generating signalling messages themselves.

Therefore, the invention proposes a second embodiment, remaining conforming with the current standardization of the SIP protocol and not making it necessary to modify installed terminals.

For example, the marker may be inserted within a particular parameter of the signalling message that, just like the signature, could be the “branch” parameter.

Typically, this is the “branch” parameter of the (chronologically) last “Via” header of each outgoing signalling message.

In some cases, some “proxy” signalling elements also modify “Record Route” headers and routing of a response message in the communication network is based on these “Record Route” headers. In these cases, the marker may also be inserted in a parameter of the record route header in each outgoing signalling message.

SIP terminal elements use the “Record-Route” header to route subsequent messages through nodes that made the query on the forward path.

In the case of a “B2BUA” (“back-to-back User Agent”) type signalling element, the marker may be inserted in the “To” header when it adopts the role of server (UAS for “User Agent Server”), and in the “From” header when it adopts the role of client (UAC for “UserAgent Client).

The marker may also be included in the “Service Route” header by a signalling proxy with the role of an S-CSCF proxy in an IMS architecture. This “Service Route” header is defined in the IEFT RFC 3608, entitled “Session Initiation Protocol (SIP) Extension Header Field for Service Route Discovery During Registration” and published in October 2003.

In all these cases, the marker may be inserted by use of a separator (the “;” following the grammar of the SIP protocol) and introduced by a specific keyword (for example the “marker=” string). It may also be inserted without the use of a keyword.

It should be noted that this additional optimisation consisting of inserting and verifying the presence of a marker is also applicable in the case in which the two signature calculations are made as indicated in RFC 3261.

In one variant, it is also possible to systematically make the signature calculation within the RCP reception means, but only to trigger the comparison in the case in which the incoming message “me” does not contain the SIP Proxy identification marker.

1) SIP Proxy comprising reception means (RCP) for incoming signalling messages “me” conforming with the SIP protocol originating from a communication network (N), processing means (TRT) to provide outgoing signalling messages (ms) from said incoming signalling messages possibly modifying some of the parameters of said incoming signalling messages, and sending means (EMS) to send said outgoing signalling messages (ms) onto said communication network (N), said reception means comprising a loop detection mechanism consisting of calculating a signature for an incoming signalling message from a set of parameters of said incoming signalling message, and detecting a loop by comparing said signature with values inserted in a particular parameter of said incoming signalling message, characterised in that said sending means (EMS) insert said signature in said particular parameter of the outgoing signalling message (ms) corresponding to said incoming signalling message (me).

2) Proxy according to claim 1, in which said particular parameter is the “branch” parameter, and said signature is an alphanumeric string.

3) Proxy according to claim 1, in which said set of parameters comprises the “via” parameter excluding the single random identifier.

4) Proxy according to claim 3, in which said set of parameters comprises at least “From”, “To”, “Call Id”, “Route”, “Via”, “Query URI”, “Proxy Authorization”, “Proxy require”, “CSeq”.

5) Proxy according to claim 1, in which said set of parameters is conforming with “draft-ieff-sip-fork-loop-fix-04.txt”

6) Proxy according to claim 1, in which said signature is separated from other values of said “branch” parameter by a separator such as a dash.

7) Proxy according to claim 1, also having means for inserting a marker representing it and identifying it univocally into said outgoing messages, and means of not signing the calculation for said incoming signalling message if there is no marker identifying said proxy within an incoming signalling message.

8) Proxy according to claim 7, in which said marker is based on the physical address of said proxy.

9) Proxy according to claim 7, in which said marker is obtained from a naming server.

10) Communication architecture, conforming with the IMS standard, comprising a plurality of P-CSCF, I-CSCF et S-CSCF type proxies, characterised in that at least one of said proxies is conforming with claim 1.

11) Method for sending signalling messages, particularly conforming with the SIP protocol, within a set of proxies in a communication network, in which each proxy passed through receives an incoming signalling message, outputs an outgoing signalling message from said incoming signalling message, possibly modifying some parameters of said incoming signalling message, and sends said outgoing signalling message, method in which a loop detection mechanism is used that consists of calculating a signature starting from a set of parameters of said incoming signalling message, and detecting a loop by comparing said signature with values inserted in a particular parameter of said incoming signalling message, characterised in that said signature is inserted in said particular parameter of the outgoing signalling message corresponding to said incoming signalling message.

12) Method according to the claim 11, in which said particular parameter is the “branch” parameter, and said signature is an alphanumeric string.

13) Method according to claim 11, in which said set of parameters comprises the “via” parameter excluding the single random identifier.

14) Method according to claim 13, in which said set of parameters comprises at least “From”, “To”, “Call Id”, “Route”, “Via”, “Query URI”, “Proxy Authorization”, “Proxy require”, “CSeq”.

15) Method according to claim 11, in which said set of parameters is conforming with “draft-ietf-sip-fork-loop-fix-04.txt”

16) Method according to claim 13, in which said signature is separated from other values of said “branch” parameter by a separator or a dash.

17) Method according to claim 11, in which a marker representative of said proxy and identifying it univocally is inserted in said outgoing messages, and no signature calculation is done for said incoming signalling message if there is no marker identifying said proxy in the incoming signalling message.

18) Method according to claim 1, in which said marker is based on the physical address of said proxy.

19) Method according to claim 17, in which said marker is obtained from a naming server.

20) Method for sending signalling messages, particularly conforming with the SIP protocol, within a set of proxies in a communication network, in which each proxy passed through receives an incoming signalling message, outputs an outgoing signalling message from said incoming signalling message, possibly modifying some parameters of said incoming signalling message, and sends said outgoing signalling message, method in which a loop detection mechanism is used that consists of calculating a signature starting from a set of parameters of said incoming signalling message, and detecting a loop by comparing said signature with values inserted in a particular parameter of said incoming signalling message, characterised in that a marker representing said proxy is inserted in said outgoing signalling messages, and in that said loop detection mechanism is only used for an incoming signalling message if said incoming signalling message contains a marker identifying said signalling element.

21) Method according to claim 20, in which said signature is inserted in said particular parameter of the outgoing signalling message corresponding to said incoming signalling message.

22) Method according to claim 20, in which said marker is based on the physical address of said proxy.

23) Method according to claim 20, in which said marker is obtained from a naming server.

24) Method according to claim 20, in which said particular parameter is the “branch” parameter, and said signature is an alphanumeric string.

25) Method according to claim 20, in which said set of parameters comprises the “via” parameter excluding the single random identifier.

26) Method according to claim 25, in which said set of parameters comprises at least “From”, “To”, “Call Id”, “Route”, “Via”, “Query URI”, “Proxy Authorization”, “Proxy require”, “CSeq”.

27) Method according to claim 20, in which said set of parameters is conforming with “draft-ietf-sip-fork-loop-fix-04.txt”
